(19) United States
(12) Patent Application Publication
(10) Pub. No.: US 2004/0048010 A1
(43) Pub. Date: Mar. 11, 2004

(54) Elevated framing display cover

(75) Inventor: Gene R. Will, Vancouver, WA (US)

Correspondence Address: Kolisch, Hartwell, Dickinson,, McCormack & Heuser, 200 Pacific Building, 520 S.W. Yamhill Street, Protland, OR, 97204, US

(73) Assignee: Geme Art, Inc.

(21) Appl. No.: 10/242,587

(22) Filed: Sep. 11, 2002

(51) Int. Cl. B32B 1/02

(52) U.S. Cl. 428/34.1

(57) ABSTRACT

A plastic display cover designed for mounting in a frame, including a planar lip, at least one planar viewing surface and adjoining sidewalls. Extending along the periphery of the display cover, the planar lip is shaped to fit and be bound in the position within a frame traditionally occupied by the edges of standard framing glass. The at least one planar viewing surface is elevated from the plane of the planar lip and is connected to the surrounding planar lip by adjoining sidewalls. The adjoining sidewalls form a dome-like casement, extending from the plane of the planar lip to the plane of the at least one viewing surface.

### BACKGROUND OF THE INVENTION

The present invention relates to framing devices that facilitate the display of three-dimensional items.

While standard wall-hanging frames with framing glass are capable of accommodating two-dimensional items such as posters and photographs, alternate means are necessary to display three-dimensional objects. As a result, so-called shadow boxes are commonly used in order to frame such non-planar items. A shadow box is a box-type frame, which in its most basic embodiment consists of a box-shaped enclosure attached to the rear of a traditional frame that employs standard framing glass. In this manner, a shadow box increases the depth of a frame to the rear of the display glass, thereby increasing its holding capacity as well. These devices are currently used because their recessed nature creates the depth needed to frame such items as three-dimensional art, flowers, and other memorabilia.

Shadow boxes, however, fall prey to several inherent disadvantages when considered in relation to traditional, standard frames. Due to their role of displaying three-dimensional items that cannot be secured by traditional framing methods, it is common for shadow boxes to be demanded in a wide variety of custom shapes and sizes. Unfortunately, the custom manufacture and purchase of shadow boxes can be quite expensive. As a result, alternate, more economical means of displaying three-dimensional items would be very desirable and valuable.

Moreover, the very characteristic of additional frame-depth, which lends shadow boxes their utility, also serves to reduce their effectiveness. While their purpose is to display three-dimensional objects, the excessive sidewalls of recessed box frames dramatically impair the ability of such objects to be viewed from a side angle. Due to this limitation, shadow boxes are incapable of providing satisfactory display means in many framing applications. Consequently, the consideration of alternate methods of framing three-dimensional items may prove to be very beneficial to the art.

### BRIEF SUMMARY OF THE INVENTION

The present invention provides a plastic display cover designed for mounting in a frame. The invention includes a planar lip, at least one planar viewing surface and adjoining sidewalls. The planar lip extends along the periphery of the display cover and is shaped to fit and be bound in the position within a frame traditionally occupied by the edges of standard framing glass. The at least one planar viewing surface is elevated from the plane of the planar lip, and adjoining sidewalls connect the at least one planar viewing surface with the surrounding planar lip, extending from the plane of the planar lip to the plane of the at least one viewing surface and forming a dome-like casement.

### BRIEF DESCRIPTION OF THE FIGURES

FIG. 1 is an isometric view of the first embodiment of a display cover mounted in a frame according to the present invention.

FIG. 2 is an isometric view of the first embodiment of a display cover according to the present invention.

FIG. 2-A is a side view of the first embodiment of a display cover according to the present invention.

FIG. 2-B is a side view of the second embodiment of a display cover according to the present invention.

FIG. 3 is a front view of the third embodiment of a display cover according to the present invention.

FIG. 4 is a side view of the third embodiment of a display cover according to the present invention.

FIG. 5 is an isometric view of the fourth embodiment of a display cover according to the present invention.

FIG. 6 is an isometric view of the fifth embodiment of a display cover according to the present invention.

FIG. 7 is an isometric view of the sixth embodiment of a display cover according to the present invention.

FIG. 8 is an isometric view of the seventh embodiment of a display cover according to the present invention.

### DETAILED DESCRIPTION OF THE PREFERRED EMBODIMENTS

The present invention provides a transparent, raised display cover for use in framing applications. The elevated viewing surface of the invention allows the multi-directional exhibition of three-dimensional objects when used in conjunction with a display frame. Also, its implementation is suitable in both vertical and horizontal applications. The objects of the invention are best achieved when the invention takes the form of the embodiments depicted in the figures. While these embodiments will be each discussed as this description continues, it is noted that the invention is not limited to the particular embodiments shown.

First Embodiment

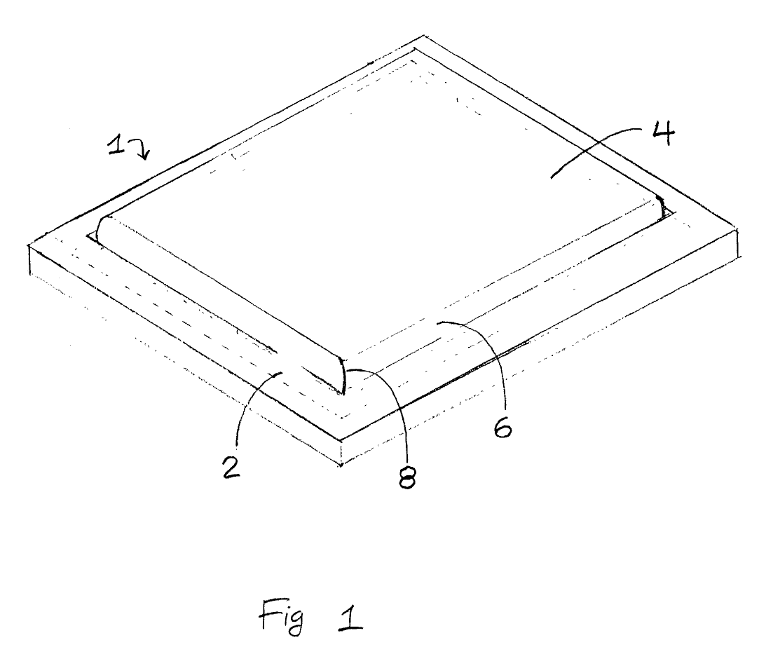

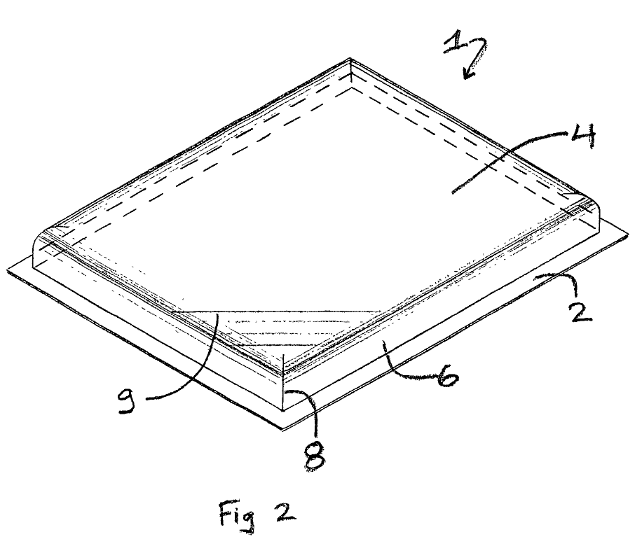

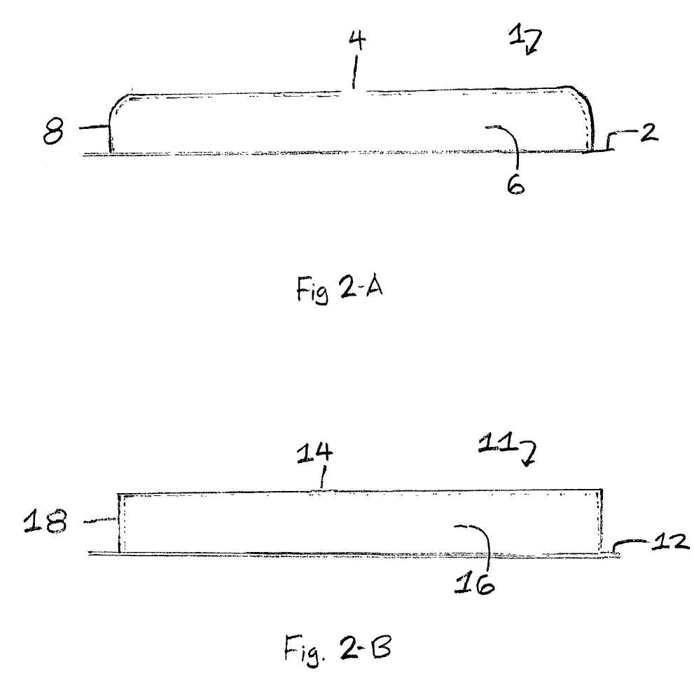

Referring now to FIGS. 1, 2, and 2-A, a dome-like display cover 1 is manufactured from polyvinyl chloride (PVC) or some other plastic material such as high impact polystyrene (HIPS), acrylonitrile butadiene styrene (ABS), polyethylene (PE) or polypropylene (PP) to fit either stock or custom frames. Such manufacture is straightforward and inexpensive, and provides a display cover 1 of sufficient thickness (approximately ⅛″) so as to convey an impression of substance and quality. The use of plastic ensures that the display cover 1 is not overly fragile. This characteristic represents a major advantage over traditional framing glass. Additionally, plastic display covers may be constructed with smooth, clear viewing surfaces or, alternately, they may be surfaced with artistic effects such as fog, brush-strokes, or texturing as depicted generally by texture lines 9 in FIG. 2.

Planar lip 2 extends along the entire periphery of display cover 1, as shown in FIG. 2. Display cover 1 is often held fixedly inside a frame by lip 2, typically about one-quarter of an inch in width, which is generally secured in the position traditionally occupied by the edges of standard framing glass. As a result, although display covers according to the present invention are mounted within frames in essentially the same manner as framing glass, their domed design provides a cavity between the elevated viewing surface and the plane of the frame backing, which may be occupied by three-dimensional objects.

According to various embodiments of the present invention, the characteristics by which display cover 1 may vary include lip 2 shape, depth, viewing surface 4 shape and sidewall 6 surfacing and jointing. In terms of their lip 2 shape, display covers 1 may be conveniently manufactured to fit the varying dimensions of custom and standard frames. For example, while display covers 1 may be produced to accommodate the dimensions of standard portrait frames, such as 3×5″, 5×7″ and 8×10″, their lips 2 may also be constructed so as to fit irregularly sized frames or custom shapes, as discussed below.

The depth of a display cover 1 is a measure of the distance between its viewing surface 4 and the planar region circumscribed by its outer lip 2. Cover 1 depth may vary in order to appropriately satisfy the requirements of individual display applications. For example, the appropriate depth of a cover 1 used to exhibit wall-mounted fishing flies may be one inch, while the depth of a cover 1 used to display a dried wedding bouquet may be approximately six inches.

Embodiments of the present invention provide planar, elevated viewing surfaces 4. The borders of such surfaces may share the shapes of the corresponding lips 2 of their display covers 1. For example, a 5×10″ rectangular display cover 1 may provide a congruent 4×8″ rectangular viewing surface 4. However, according to the present invention, display covers 1 may also incorporate viewing surfaces 4 which are not sized congruently or which are shaped differently than their accompanying lips 2, as discussed below. In addition, the plane of a viewing surface 4 may be parallel to the plane of the surrounding lip 2 or, alternatively, the viewing surface 4 may be tilted, also discussed below.

Various embodiments of the sidewalls 6 which connect the elevated viewing surfaces 4 of display covers 1 with their surrounding lips 2 and which are in accordance with the present invention will be explained with reference to the paradigm case of a 5×10″ rectangular display cover 1 including a 4×8″ viewing surface 4. In such an embodiment, there exist four naturally differentiated sidewalls 6 corresponding to the four-sided shape of the lip 2 and viewing surface 4. FIG. 2-A offers a side elevation view of one such sidewall 6. The surface of each sidewall 6 may be straight or gently curved, as discussed below.

In a 5×10″ rectangular embodiment of a display cover 1, each of the four sidewalls 6, shaped as previously taught, may also join to their contiguous sidewalls 6 in a variety of fashions. For example, as best shown in FIG. 2-A, the intersections of sidewall 6 surfaces may be gently beveled to create a smooth, seamless transition in conjunction with the beveled surfaces of the adjoining sidewalls 6. In the case of display covers 1 having identical viewing surfaces 4 and lip 2 shapes, as with the 5×10″ paradigm example, the sidewall 6 and joints 8, whether ridged or smooth, commonly extend between the corners of the lip and their corresponding corners on the viewing surface 4.

Second Embodiment

Turning now to FIG. 2-B, the side view of the second embodiment of display cover 11 according to the present invention is shown. The components and features of display cover 11 indicated by reference numerals 12-18 correspond with, and are substantially the same as the components and features of display cover 1 in FIGS. 1, 2, and 2-A, and described above. For the purpose of brevity, these components and features will not be described in detail again with regard to FIG. 2-B.

Display cover 11 differs, however, from display cover 1 in that each of the four sidewalls 16 form ridged seams located where the extensions of their respective surfaces naturally intersect, one extending from each corner of the lip 12 to each corresponding corner of the viewing surface 14.

Third Embodiment

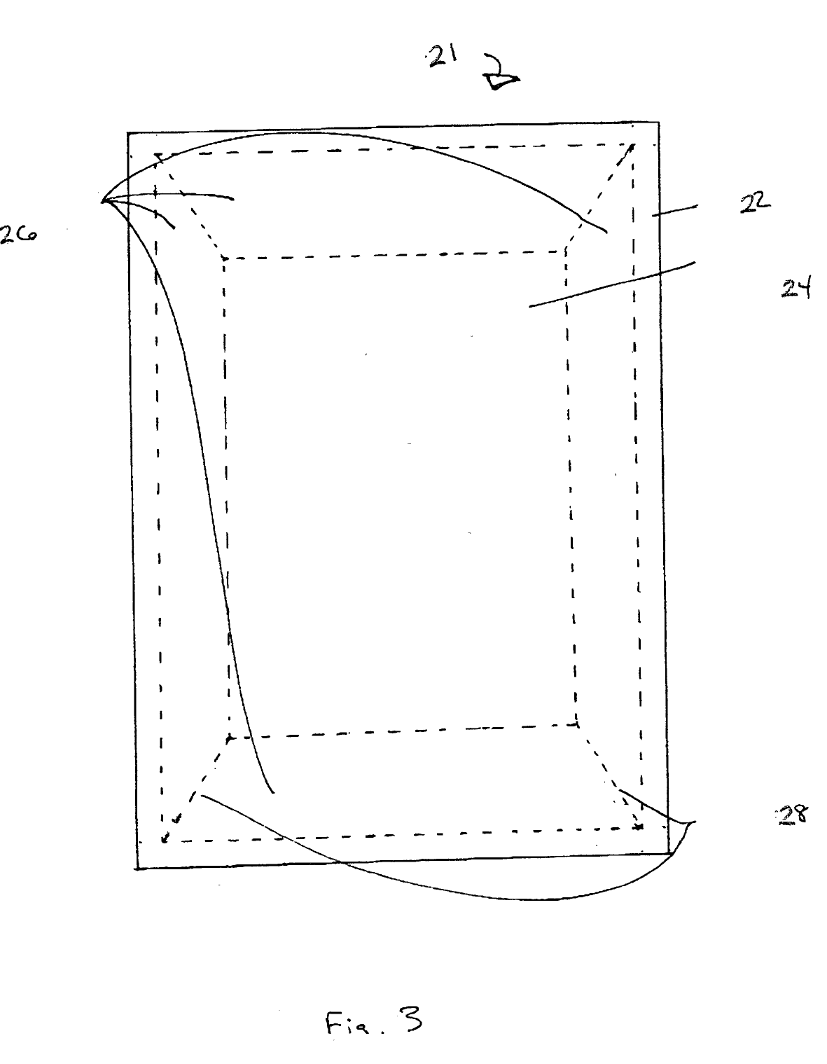

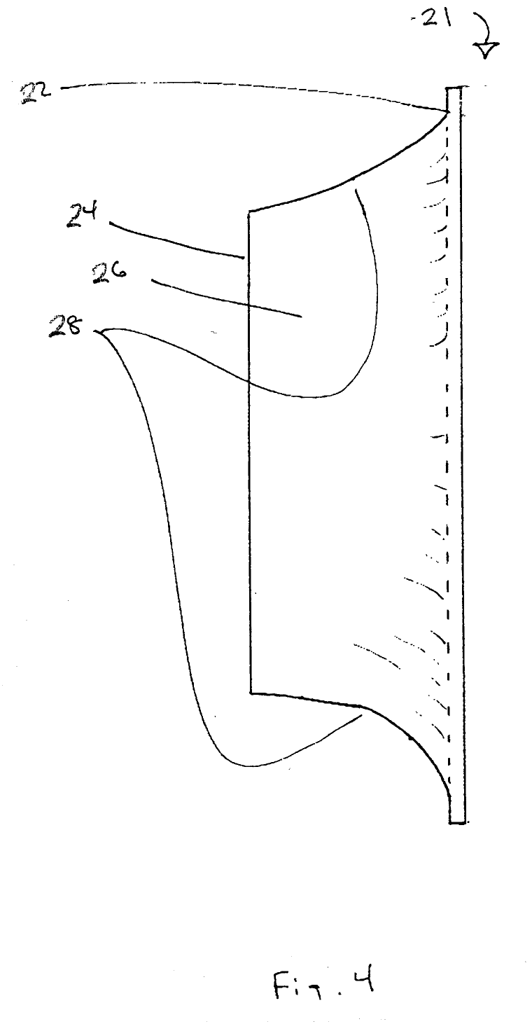

Referring now to FIGS. 3-4, the third embodiment of display cover 21 according to the present invention is shown. The components and features of display cover 21 indicated by reference numerals 22-28 correspond with, and are substantially the same as the components and features of display cover 1 in FIGS. 1, 2, and 2-A, and described above. For the purpose of brevity, these components and features will not be described in detail again with regard to FIGS. 3-4.

Display cover 21 differs, however, from display cover 1 in that the surface of each sidewall 26 is gently curved, connecting the viewing surface 24 to the lip 22 in a smooth, rounded bevel. In addition, display cover 21 has a viewing surface 24 that may not be sized congruently to its accompanying lips 22. For example, a 5×10″ rectangular display cover 1 may have a 4×9″ rectangular viewing surface 24, instead of a more congruent 4×8″ rectangular viewing surface 24.

Fourth Embodiment

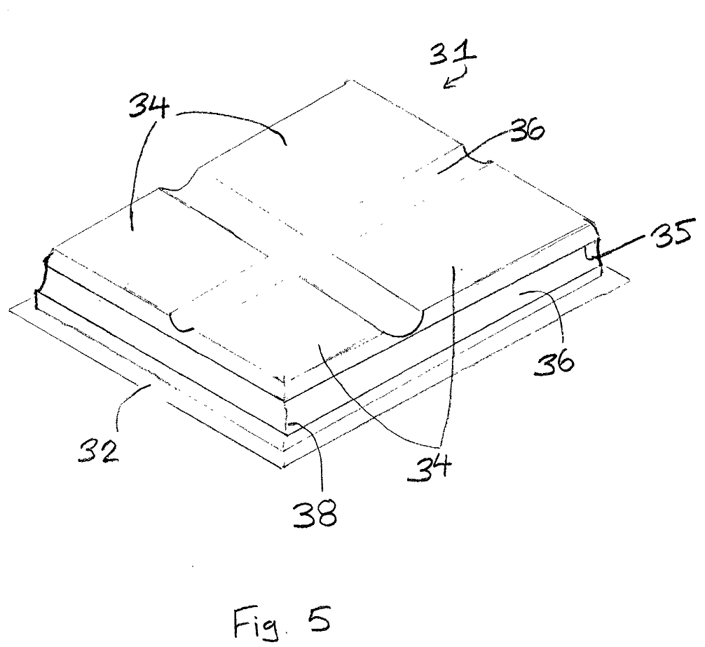

Turning now to FIG. 5, the fourth embodiment of display cover 31 according to the present invention is shown. The components and features of display cover 31 indicated by reference numerals 32-38 correspond with, and are substantially the same as the components and features of display cover 1 in FIGS. 1, 2, and 2-A, and described above. For the purpose of brevity, these components and features will not be described in detail again with regard to FIG. 5.

Display cover 31 differs, however, from display cover 1 in that display cover 31 includes multiple viewing surfaces 34. A single display cover 31 may have multiple, coplanar viewing surfaces 34, each separated by a recessed channel of adjoining sidewalls 36. Such a display cover 31 with segmented viewing surfaces 34 may be well suited for the exhibition of multiple, separately mounted, keepsakes, such as a collection of silver spoons.

Display cover 31 also differs from display cover 1 in that sidewall 36 comprises a series of parallel ridges 35, joined smoothly to one another, which ornately connect the viewing surface 34 with the lip 32.

Fifth Embodiment

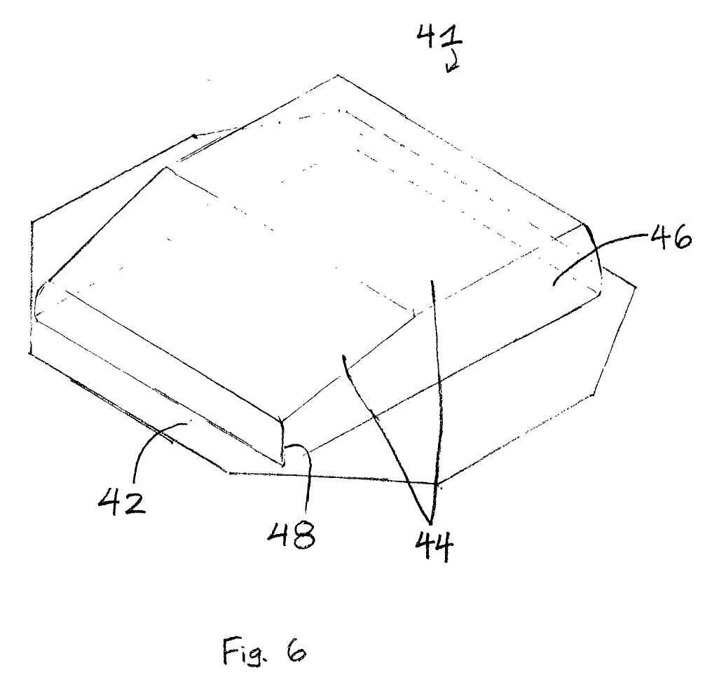

Turning now to FIG. 6, the fifth embodiment of display cover 41 according to the present invention is shown. The components and features of display cover 41 indicated by reference numerals 42-48 correspond with, and are substantially the same as the components and features of display cover 1 in FIGS. 1, 2, and 2-A, and described above. For the purpose of brevity, these components and features will not be described in detail again with regard to FIG. 6.

Display cover 41 differs, however, from display cover 1 in that the lips 42 are constructed so as to fit irregularly sized square, rectangular, polygonal, circular, and oblong frames. In addition, the lips 42 may also be designed in custom shapes such as that of a star, horseshoe, or heart. Display cover 41 also differs in that the plane of at least one viewing surface 44 is tilted with respect to the plane of the lip 42.

Sixth Embodiment

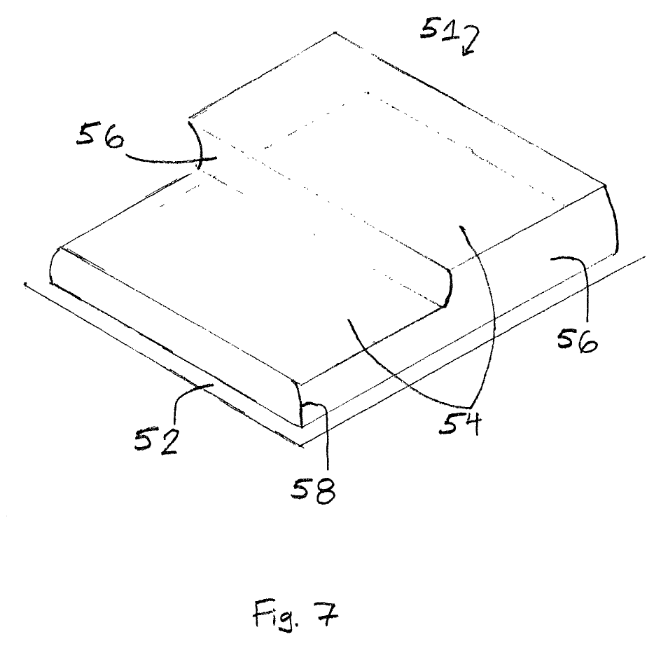

Turning now to FIG. 7, the sixth embodiment of display cover 51 according to the present invention is shown. The components and features of display cover 51 indicated by reference numerals 52-58 correspond with, and are substantially the same as the components and features of display cover 1 in FIGS. 1, 2, and 2-A, and described above. For the purpose of brevity, these components and features will not be described in detail again with regard to FIG. 7.

Display cover 51 differs, however, from display cover 1 in that display cover 51 includes multiple viewing surfaces 54 positioned at multiple depths from the common lip 52. Multi-level viewing surfaces 54 may be segmented, one from another, by sidewalls 56, as in the case of multiple coplanar viewing surfaces 54. However, a viewing surface 54 may also be connected to sidewalls 56 which extend or recede from the midst of an encompassing viewing surface 54. Such a multi-level display may be ideal for framing items such as a woman's sun bonnet, in which case one viewing surface 54 may cover the thin brim of the hat while a second viewing surface 54 of greater depth extends beyond the first to enclose the taller crown of the hat.

A great deal of the utility of the present invention arises from its ability to serve as an alternative to traditional shadow box frames. However, in some applications, display covers 51 may be well employed in conjunction with shadow boxes. For framing scenarios involving objects of such significant depth that they cannot be appropriately mounted on a traditional frame, a display cover 51 may instead be used with a shadow box in order to provide the necessary relief.

Seventh Embodiment

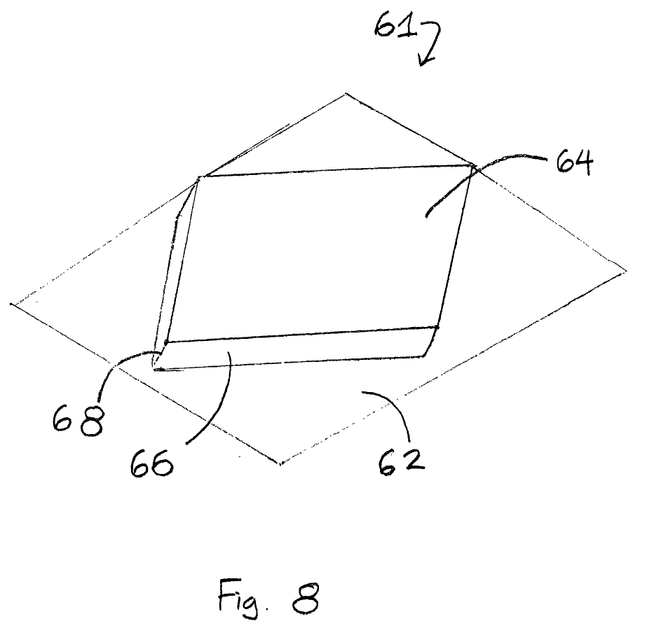

Turning now to FIG. 8, the seventh embodiment of display cover 61 according to the present invention is shown. The components and features of display cover 61 indicated by reference numerals 62-68 correspond with, and are substantially the same as the components and features of display cover 1 in FIGS. 1, 2, and 2-A, and described above. For the purpose of brevity, these components and features will not be described in detail again with regard to FIG. 8.

Display cover 61 differs, however, from display cover 1 in that display cover 61 has a differently sized viewing surface 64 in the shape of a square, polygon, circle, oval, or some other design such as a heart. In the case of custom display covers 61 having a viewing surface 64 and lip 62 that are shaped differently, joints 68 may be positioned and surfaced uniquely in each application. For example, in the case of a square display cover 61 with a heart shaped viewing surface 64, ridged joints 68 extending inward from the corners of the lip 62 may be gradually blended into smooth, seamless sidewalls 66 surrounding the viewing surface 64.

I claim:

1. A plastic display cover designed for mounting in a frame, comprising:
a planar lip extending along the periphery of said display cover, where said planar lip is shaped to fit and be bound in the position within a frame traditionally occupied by the edges of standard framing glass;
at least one planar viewing surface elevated from the plane of said planar lip; and
adjoining sidewalls connecting said planar lip to said at least one planar viewing surface, where said sidewalls extend from the plane of said planar lip to the plane of said viewing surface, forming a dome-like casement.

2. The display cover of claim 1, where said at least one planar viewing surface includes multiple viewing surfaces, and where said multiple viewing surfaces extend in parallel planes, each of the said multiple viewing surfaces being separated from adjacent viewing surfaces by a recessed channel of adjoining sidewalls, which are in addition to said sidewalls connecting said planar lip to said at least one planar viewing surface around the periphery of said display cover.

3. The display cover of claim 1, where the plane of said at least one planar viewing surface is parallel to the plane of said planar lip.

4. The display cover of claim 1, where said at least one planar viewing surface is tilted with respect to said planar lip.

5. The display cover of claim 1, where said at least one planar viewing surface is smooth and transparent.

6. The display cover of claim 1, where the surface of said at least one planar viewing surface includes artistic detailing to create an effect such as that of fog, brush-strokes, texturing, or an embossed design.

7. The display cover of claim 1, where said planar lip is shaped as a polygon, circle or oval.

8. The display cover of claim 1, where the shape of said at least one planar viewing surface is congruent to that of said planar lip.

9. The display cover of claim 1, where the shape of said at least one planar viewing surface is substantially different from that of said planar lip.

10. The display cover of claim 1, where the surfaces of said adjoining sidewalls are gently curved, connecting said at least one planar viewing surface to said planar lip in a smooth, rounded bevel.

11. The display cover of claim 1, where each surface of said adjoining sidewalls forms a series of parallel ridges, interconnected by smooth bevels, ornately connecting said at least one planar viewing surface to said planar lip.

12. The display cover of claim 1, where the joint of each of said adjoining sidewalls with its contiguous sidewalls forms a ridged seam located where the extensions of their respective surfaces naturally intersect.

13. The display cover of claim 1, where the joint of each of said adjoining sidewalls with its contiguous sidewalls is gently beveled to create a smooth, seamless transition in conjunction with the likewise beveled surfaces of said contiguous sidewalls.

14. The display cover of claim 1, where the joint of each of said adjoining sidewalls with its contiguous sidewalls gradually blends from a ridged seam at one end, adjacent to either said at least one planar viewing surface or said planar lip, into a smooth, seamless intersection at the opposite end.

15. The display cover of claim 1, where said at least one planar viewing surface includes multiple viewing surfaces, and where said viewing surfaces are positioned at multiple depths with respect to the surrounding said planar lip.
